(19) United States
(12) Patent Application Publication
(10) Pub. No.: US 2022/0256673 A1
(43) Pub. Date: Aug. 11, 2022

(54) System and Method for Monitoring Illumination Intensity

(71) Applicant: Pan American Systems Corporation, Virginia Beach, VA (US)

(72) Inventors: Rolando E. Timm, Virginia Beach, VA (US); Karin G. Timm, Spring, TX (US)

(73) Assignee: Pan American Systems Corporation, Virginia Beach, VA (US)

(21) Appl. No.: 17/503,118

(22) Filed: Oct. 15, 2021

Related U.S. Application Data
(60) Provisional application No. 63/092,136, filed on Oct. 15, 2020.

(51) Int. Cl. H05B 47/11; H05B 47/19; H05B 45/22

(52) U.S. Cl. CPC H05B 47/11; H05B 45/22; H05B 47/19

(57) ABSTRACT

A luminosity intensity monitoring system for maintaining compliance with a regulated level of visibility of specific-purpose lighting systems. The luminosity intensity monitoring system may be compatible with both incandescent and LED-based lighting systems, and may incorporate “smart” technology built into a luminaire or separately installed circuitry, and may be installed as original equipment or configured for retro-fit applications. The luminosity intensity monitoring system may be configured to present an early visible or audible warning which may indicate the visibility of a luminaire may be at risk of being non-compliant with regulations set forth by convention or civil authority. Methods for monitoring luminosity intensity are provided, whereby if the luminosity intensity of a luminaire approaches or falls below a predetermined threshold, or a luminaire approaches or exceeds a predetermined duration of service, the luminosity intensity monitoring system may present a visible warning signal, or an audible warning signal, or combinations thereof.

### CROSS-REFERENCE TO RELATED APPLICATIONS

This application claims priority to U.S. Provisional Patent Application Ser. No. 63/092,136 filed Oct. 15, 2020, the entire contents of which are incorporated herein by reference thereto.

### STATEMENT REGARDING FEDERALLY SPONSORED RESEARCH OR DEVELOPMENT

Not applicable.

### BACKGROUND OF THE INVENTION

### Field of the Invention

The present disclosure relates a system and method for monitoring the luminosity output of lighting systems. More specifically, the present disclosure relates to a system and method for monitoring the visibility of illuminating systems by providing an early warning failure signal within a monitored lighting system capable of alerting that a luminaire is nearing the end of its service life as measured by its illumination intensity prior to failure of the luminaire.

### Background of the Invention

Specific-purpose lighting systems are utilized across a number of industries as a means of visually distinguishing mobile vehicles, vessels, traffic signaling, or in the demarcation of navigable boundaries. As an example, navigational lighting systems employed by maritime vessels enable a craft's position, heading, and status to be recognizable to an observer based on relative positions of specifically configured illuminating lamps, or luminaires, located about the vessel. The configuration and visibility requirements of these lighting systems for a given vessel may be mandated by convention or civil authorities holding responsibility over the waters being navigated, with these systems helping fulfill a primary objective of improved safety through collision avoidance. Typically the maritime lighting requirements must be adhered to from sunset to sunrise, and these requirements may vary, for example, based on the type or size of the vessel, or the mode by which the craft may be underway, for example whether by sail, under oars, or power-driven.

Furthering this example, the International Maritime Organization (IMO), a specialized agency of the United Nations, maintains a comprehensive body of international conventions that govern shipping activity, including the Convention of the International Regulations for Preventing Collisions at Sea, adopted in 1972. Also known as COLREGs, and sometimes referred to as the Sea Rules of the Road, this set of conventions sets forth a range of rules pertaining to various aspects of navigation, several of which concern lighting requirements for seaworthy vessels or other vessels being towed. These conventions are observed by a number of civil authorities having jurisdiction over navigable waters world-wide. For example, the U.S. Coast Guard participates with the IMO in policy development and observes standards in keeping with the COLREGs in its regulation and enforcement activities.

While a casual observer may be familiar with red, green, or white lights they may have seen adorning a boat or ship, these navigation lights have intentionally specific configurations and ranges of visibility that are recognizable to maritime professionals which may correspond to specific operating conditions. As examples, the Navigation Rules and Regulations Handbook published by the U.S. Coast Guard, based on the COLREGs, cites in Rules 20 through 31 the placement and degrees of visibility for Sidelights (red on port, green on starboard, “each showing an unbroken light over an arc of the horizon of 112.5 degrees and so fixed as to show the light from right ahead to 22.5 degrees abaft the beam on its respective side”), and the Sternlight (white, “showing an unbroken light over an arc of the horizon of 135 degrees and so fixed as to show the light 67.5 degrees from right aft on each side of the vessel”). Further specified in the Handbook are requirements governing the intensity of the lights, correlating to the visible distance requirements for vessels of varying sizes. For example, vessels of 50 meters or more in length require a Masthead light to be visible for 6 miles, while a sidelight for the same vessel must be visible for 3 miles. Smaller vessels are generally held to reduced standards of visibility through a tiered classification system based on vessel length.

Traditional incandescent navigational lighting systems may experience service lives ranging from 500 to 800 hours (generally correlating to roughly 6 months of operation). Since a given vessel may require numerous such navigation lights, an ongoing effort may be undertaken to continually monitor the operational status of the lights and replace lamps that no longer operate. In larger vessels having lighting systems operating on 120 volt A/C circuits, crew engineers may be tempted to reduce the voltage to the lighting circuits, effectively lowering the operating temperature of the lights and thus extending their service lives, but such a reduction of voltage also reduces the luminosity intensity of the light. This reduction in luminosity intensity simultaneously correlates to a reduction in visibility, which may render the light illegal in view of applicable regulations.

As with several other lighting-related industries, the maritime industry is presently experiencing a transition from traditional incandescent lighting systems to more modem lighting systems based on Light Emitting Diode (LED) technology. Generally speaking, the transition from incandescent to LED lighting systems in any industry is motivated by energy efficiency gains of the LED technology as well as extended service life benefits of LED-based luminaires. Despite their extended service lives, LED lighting systems typically experience a degradation of luminosity over the lifetime of the lamp, correlating to a reduction in visibility, and thus potentially rendering an LED luminaire illegal despite an appearance that the light may be otherwise operational.

Further complicating the use of LEDs in retrofit applications, a replacement LED luminaire may require differing mechanical or electrical accommodations than a previously used incandescent lamp. Within the maritime industry large degrees of mechanical or electrical variation among luminaires may subject a ship's owners and crew to additional costs or safety risks, for example, if a lamp requiring replacement is positioned at the top of a tall mast and a replacement LED luminaire is not a direct-fit replacement.

At present, monitoring solutions are available on the market which will only provide notification of luminaires which bum out, whether incandescent or LED, for example, as described by U.S. Pat. No. 7,535,375. Examples of such monitoring solutions may comprise a panel of lit indicators which indicate whether a luminaire is operational (wherein the indicator may be green) or whether a luminaire is not operational (wherein the indicator may be red). Typically these existing monitoring systems function based on an electrical draw across a lighting circuit, whether voltage or current may be measured, and are limited to indicating only whether a luminaire may be operational or not, rather than monitoring luminosity intensity and thus their compliance with governing visibility requirements. Consequently, there is a need for a means of improved monitoring of the visibility of specific-purpose lighting systems in view of compliance with convention or civil authority requirements while maintaining the operational condition of a vessel's luminaires.

### BRIEF SUMMARY OF SOME OF THE PREFERRED EMBODIMENTS

These and other needs in the art are addressed in one embodiment by a luminosity intensity monitoring system that is capable of measuring the luminosity intensity of individual luminaires and gauging the measured luminosity against predetermined levels of intensity, which may correlate to regulated minimum levels of visibility. In embodiments, the luminosity intensity monitoring system may be compatible with both incandescent and LED-based lighting systems, and may comprise “smart” technology built into a luminaire or separately installed circuitry. In embodiments, the illumination intensity system may be installed as original equipment or may be configured for retro-fit applications, and may be configured to present a visible or audible warning, indicating the visibility of a luminaire has fallen below a predetermined threshold.

In alternate embodiments, the luminosity intensity monitoring system may be configured for use in lighting systems on maritime vessels, offshore platforms, navigation devices such as buoys, stationary objects including bridges, in transportation applications including automotive, trucking, and rail, on aircraft, spacecraft, or other vessels, craft, objects, or assets subject to compliance with a regulated level of visibility set forth by convention or civil authority.

The luminosity intensity monitoring system may be implemented in a manner which may employ one or more methods for monitoring illumination intensity of an illumination source. Embodiments of the methods may comprise one or more monitoring steps, wherein a luminaire may be determined to be outputting an acceptable or unacceptable illumination intensity in relation to a regulated minimum visibility. A luminaire may be determined to be outputting an unacceptable illumination intensity based on one or more criteria, which may include a measured illumination intensity of the luminaire falling below a predetermined value of illumination intensity, a measured illumination intensity of the luminaire degrading to a level below a stated operational intensity of the luminaire, or the service life of a luminaire exceeding predetermined duration of use which may be associated with a degradation in illumination intensity.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an illumination system;

FIG. 2 illustrates an embodiment of an illumination monitoring system disposed in a luminaire;

FIG. 3 illustrates an operational block diagram of an embodiment of an illumination monitoring system;

FIG. 4a illustrates a first embodiment of a method for monitoring illumination intensity;

FIG. 4b illustrates a second embodiment of a method for monitoring illumination intensity; and

FIG. 4c illustrates a third embodiment of a method for monitoring illumination intensity.

### DETAILED DESCRIPTION OF THE PREFERRED EMBODIMENTS

Described herein are systems and methods for monitoring an illumination intensity of a lighting system. In embodiments, the luminosity intensity monitoring system may be comprised of components which may be disposed within a luminaire, a plurality of luminaires, a lighting circuit, a plurality of lighting circuits, a separately housed control panel, a plurality of separately housed control panels, or combinations thereof. One or more of the components may be configured to measure a luminosity intensity of one or more luminaires for comparison with a predetermined level of luminosity, wherein the predetermined level of luminosity may correlate to a minimum acceptable level of visibility of the one or more luminaires. If the measured luminosity intensity of the luminaire falls below a predetermined minimum level, the luminosity intensity monitoring system may present a visible warning, an audible warning, or combinations thereof prior to the luminaire becoming unable to meet a regulated visibility distance. In alternate embodiments, the luminosity intensity monitoring system may present a similar “early warning” signal, which may be visible, audible, or combinations thereof, if a duration of operating a luminaire approaches or exceeds a predetermined service life after which the luminaire's output may be expected to have diminished below a level meeting a regulated visibility distance.

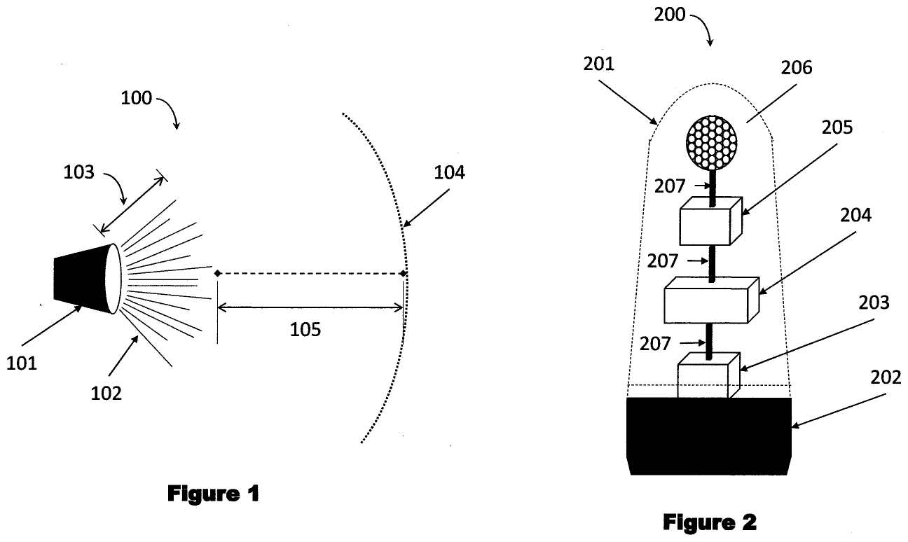

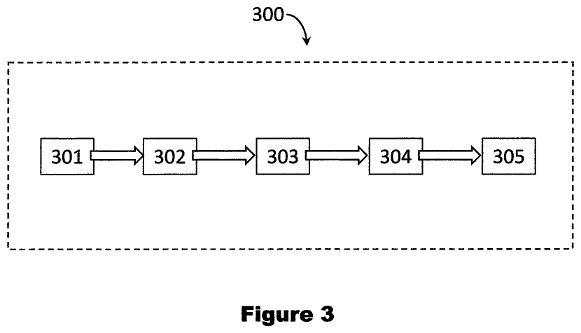

The descriptions of the system for monitoring illumination intensity which follow make reference to FIGS. 1-3, in which FIG. 1 illustrates an embodiment of an illumination system, FIG. 2 illustrates an embodiment of an illumination monitoring system disposed in a luminaire, and FIG. 3 illustrates an operational block diagram of an embodiment of an illumination monitoring system.

FIG. 1 illustrates an embodiment of illumination system 100. Illumination system 100 may comprise illumination source 101, which may be capable of producing illumination 102 having luminosity intensity 103. Illumination 102 may radiate across illumination arc 104, and may radiate over distance 105.

Illumination source 101 may be any electrical device capable of generating or providing illumination. In embodiments, illumination source 101 may be an incandescent light source, a light emitting diode light source, or combinations thereof. In embodiments, illumination source 101 may involve a fixed orientation, may be provided with a variable or adjustable orientation, or may be affixed to a stationary object, affixed to a mobile object, rotate about a fixed axis, or be allowed to otherwise adjust in orientation, for example, across yaw, pitch, or roll, or combinations thereof.

Illumination 102, may be any form of directly visible, indirectly visible, or invisible radiation emitting from illumination source 101. In embodiments, illumination 102 may include one or more wavelengths of visible light. For example, illumination 102 may comprise one or more wavelengths of light forming white, red, orange, yellow, green, blue, indigo, or violet light, or combinations thereof. Examples of invisible radiation may comprise infrared, ultraviolet, or other such wavelengths of radiation which may not be visible. Illumination 102 may further encompass a measure of color temperature, which may be expressed in degrees Kelvin or similar measures of color temperature.

Illumination intensity 103 may comprise a measurable radiating output of illumination source 101. In embodiments, illumination intensity 103 may be expressed as a measure of lumens, watts, watts-equivalent, or combinations thereof. Illumination intensity 103 may be fixed, variable, or may increase or reduce over time. In embodiments, an illumination intensity 103 produced by illumination source 101 may reduce, diminish, or degrade over a length of time or over a serviceable life of illumination source 101 at a rate which may be predicable or able to be estimated. In alternate embodiments, illumination intensity 103 may be adjustable, may modulate, or may be caused to modulate over fixed or variable measures of time. Examples of a modulating illumination intensity 103 may include the familiar red, green, and white aircraft position or navigation lighting which may be regulated by the U.S. Federal Aviation Administration, or an antenna tower lighting system which may be regulated by the U.S. Federal Communications Commission.

Illumination arc 104 may comprise a segment of an imaginary circle surrounding illumination source 101 which may exist in any orientation in three-dimensional space surrounding illumination source 101, and within which illumination 102 may be detectable. In embodiments, illumination arc 104 may consist of a semi-circular, circular, semi-spherical, or spherical shape, and may be expressed as a measure of degrees, an orientation relative to a point of reference, an orientation relative to a plane of reference, or combinations thereof. In embodiments, illumination arc 104 may comprise an arc of illuminating radiation measuring between and including 0 and 360 degrees in any orientation relative to illumination source 101. For example, illumination arc may comprise an arc of illuminating radiation measuring between 0 and 30 degrees, between 0 and 60 degrees, between 0 and 90 degrees, between 0 and 120 degrees, between 0 and 180 degrees, between 0 and 270 degrees, or 360 degrees in any orientation relative to illumination source 101. In a specific example, illumination arc 104 may comprise a range of illuminating radiation emitting from a light source which may be radiate across a horizontal arc of 112.5 degrees. In another example, illumination arc 104 may comprise a spherical arc which may be radiate across 360 degrees in all directions.

Distance 105 may comprise any measurable length or distance from a point or surface of illumination source 101 in any direction in three-dimensional space surrounding illumination source 101 in which illumination 102 may be visible when unobstructed. Distance 105 may be expressed in any unit of measure, which may be applicable to an application of illumination source 101 or may be specified by any jurisdictional agency responsible for regulating an application of illumination source 101. For example visible distance may be expressed as a quantity of meters, feet, kilometers, miles, nautical miles, or combinations thereof.

In embodiments, illumination source 101 may provide or communicate navigation information. In embodiments, illumination 102 may provide or communicate directly visible navigation information, for example colored port and starboard illumination in maritime applications, indirectly visible navigation information; for example in landing signal applications onboard aircraft carriers which may be reflected to incoming aircraft, or modulating navigation information; for example in rotating green-white air field markers or pulsating lighting systems affixed to communications towers.

In embodiments, the illumination source 101 of illumination system 100 may house, or be provided by, one or more luminosity intensity monitoring systems 200, which will now be described.

FIG. 2 illustrates an embodiment of luminosity intensity monitoring system 200, which may comprise enclosure 201 disposed on, or attached to power supply contact 202 and may enclose or surround one or more monitoring system components, which may include one or more drivers 203, sensors 204, processing units 205, luminosity outputs 206, or combinations thereof. Luminosity intensity monitoring system 200 may further comprise one or more wiring systems 207, which may provide power, communications, or combinations of power and communications between one or more components of the luminosity intensity monitoring system.

In embodiments, each of the one or more components comprising luminosity intensity monitoring system 200 may be attached to a separate or common mounting platform (not shown). For example, one or more of the monitoring system components may be mounted to a printed circuit board, which may provide surface mounted, through-hole mounted, or combinations of surface mounted or through-hole mounted attachment points for one or more of the monitoring system components. In embodiments, the mounting platform may provide integrated systems for receiving power, distributing power, transmitting or receiving wired or wireless communications, or combinations thereof from or to the one or more components mounted thereto.

Driver 203 may provide luminosity intensity monitoring system 200 with an ability to control a flow of current through one or more components of luminosity intensity monitoring system 200. In embodiments, driver 203 may control a flow of current powering luminosity output 206.

Sensor 204 may provide luminosity intensity monitoring system 200 with an ability to detect one or more operational aspects of luminosity intensity monitoring system 200. In embodiments, luminosity intensity monitoring system 200 may comprise one or more sensors 204, each of which may be configured to sense or detect measures of luminosity output, temperature, time, or other operational or environmental conditions of luminosity intensity monitoring system 200, or combinations thereof.

Processing unit 205 may provide a monitoring and/or control function for luminosity intensity monitoring system 200. Processing unit 205 may be any processing unit suitable for receiving and processing an output from sensor 204, or combinations of one or more sensors 204, and providing an output suitable for activating, de-activating, setting, adjusting, or controlling luminosity output 206, which may be accomplished by or through power received from power supply contact 202. Processing unit 205 may be provided with a storage capability, which may include any known forms of volatile or non-volatile memory, and may be configured to provide data transmission capability, which may include any known forms of wired or wireless data transmission. Processing unit 205 may be implemented in hardware, software, or a combination of hardware and software, and may comprise one or more discrete components capable of executing one or more software instructions. Processing unit 205 may further comprise environmental protection suitable for an application in which luminosity intensity monitoring system 200 may be deployed. For example, processing unit 205 may be sealed or unsealed, or may be provided with features which may protect processing unit 205 from environmental conditions which may include humidity, vibration, salinity, air quality, temperature, or similar such environmental conditions.

Luminosity output 206 may be capable of producing an illumination 102 having a luminosity intensity 103 and which may radiate across an illumination arc 104 and may radiate over a distance 105.

FIG. 3 illustrates an operational block diagram of an embodiment of luminosity monitoring system 300, which may comprise power input 301, driver signal 302, sensor components 303, processing unit 304, and illumination source 305. In embodiments, system 300 may be disposed in a single luminaire, disposed across a plurality of luminaires, or may comprise a distributed system of individual discrete components in addition to one or more luminaires.

Power may be provided to luminosity monitoring system 300 at power input 301. In embodiments, power may be provided to luminosity monitoring system 300 by an external source, which may comprise a component of, an infrastructure of, or may be provided to, a craft, a vessel, an object, or a structure about which luminosity monitoring system 300 may be disposed. For example, in maritime applications, power may be provided to luminosity monitoring system 300 from or through an electrical distribution panel of a vessel or craft. Power may be provided to luminosity monitoring system 300 at any voltage or amperage suitable for the application in which luminosity monitoring system 300 may be deployed, and may be provided as either direct current or alternating current. In embodiments, a voltage received at power input 301 may comprise a voltage up to 480 volts, while an amperage received at power input 301 may comprise an amperage up to 5 amps.

Driver signal 302 may allow luminosity monitoring system 300 to be provided with a step down feature such that power may be provided to one or more components 303, processing unit 304, illumination source 305, or combinations thereof, at an appropriate operational voltage and/or amperage. Driver signal 302 may further allow luminosity monitoring system 300 to activate, de-activate, set, adjust, or otherwise control the luminosity output of illumination source 305 in response to one or more outputs of processing unit 304.

Components 303 may comprise one or more discrete components which may provide an input to processing unit 304, receive an output from processing unit 304, or may act or function in a predetermined manner in response to processing unit 304. In embodiments, components 303 may comprise one or more sensors, control circuits, timers, switches, or combinations thereof, and may communicate with or receive communication from processing unit 304. One or more components 303 may provide luminosity monitoring system 300 with an ability to sense, detect, measure, monitor, activate, de-activate, set, adjust, or otherwise control a luminosity output of illumination source 305.

Processing unit 304 may be implemented in hardware, software, or a combination of hardware and software, and may involve one or more discrete components, capable of executing one or more software instructions which may provide a monitoring and/or control function for luminosity intensity monitoring system 300. Processing unit 304 may be any processing unit suitable for receiving an input from one or more components 303, providing or transmitting an output to one or more components 303, or combinations thereof. Processing unit 304 may be provided with a storage capability, which may include any known forms of volatile or non-volatile memory, and may be configured to provide data transmission capability, which may include any known forms of wired or wireless data transmission. In embodiments, the storage capability may be utilized to record a duration of operation for one or more luminaires. Processing unit 304, alone or in combination with one or more components 303, may provide luminosity intensity monitoring system 300 with an ability to activate, de-activate, set, adjust, or otherwise control a luminosity output of illumination source 305. In embodiments, processing unit 304 may be disposed in a single luminaire, distributed across a plurality of luminaires, or disposed in a discrete component in communication with one or more luminaires.

Illumination source 305 may be any electrical device capable of generating or providing luminosity monitoring system 300 with a luminosity output. In embodiments, illumination source 305 may comprise one or more illumination sources 101, or one or more luminosity intensity monitoring systems 200. Illumination source 305 may be activated, de-activated, set, adjusted, or otherwise controlled by luminosity monitoring system 300 in response to one or more outputs received from processing unit 304 or one or more components 303.

In embodiments, luminosity monitoring system 200,300 may be formed in a manner, and having a size, shape, or configuration suitable for deployment in original installations, replacement installations, retrofit installations, or combinations thereof. In embodiments, power supply contact 202 and/or power input 301 may be adapted to provide connection to and/or receive power from any power receptacle suitable to an original, replacement, or retrofit application. For example, in embodiments for the maritime industry, power supply contact 202 and power supply input 301 may be compatible with a “P28S” base light fixture and wiring system, or a custom designed base and/or wiring system.

Luminosity monitoring system 200,300 may allow a level of luminosity intensity, or a duration of service, to be measured for one or more luminaires disposed about a craft, a vessel, an object, or a structure for comparison against a predetermined level of illumination intensity. In this manner, the luminosity intensity monitoring system may be configured to monitor whether a luminaire's output may fall below a predetermined threshold which may be necessary to be maintained for compliance with governing regulations. In an embodiment, such a predetermined threshold may be configured as a unit of measure of luminosity intensity, or as a percentage reduction in luminosity intensity, while in an alternate embodiment, the luminosity intensity monitoring system may be configured to present the warning signal if the luminaire's output falls within or below a predetermined percentage of a specified measure of lumens. In an embodiment, the luminosity intensity monitoring system may be configured to monitor a duration of service of one or more luminaires in order to present a warning signal if the duration of service approaches or exceeds an expected duration after which the luminosity output is estimated or expected to have diminished below a regulated minimum visibility.

For example, a maritime navigation light regulated to meet a minimum visibility of 6 nautical miles may comprise a luminaire generating an output of at least 1,100 lumens. If the luminosity intensity of the navigational light were to degrade or diminish to a level below 1,100 lumens, the navigation light may no longer be visible at 6 nautical miles. In this example, the luminosity intensity monitoring system may be configured to generate a warning signal if the navigation light's brilliance falls below 1,100 lumens. Alternatively, the luminosity intensity monitoring system may be configured to generate a warning signal if the navigation light's brilliance falls 10% below its stated operational output.

In embodiments, processing unit 205,304 may be configured to record a length of time during which one or more luminaires may be deployed in an operational state for comparison against a predetermined length of time after which a luminosity output of the one or more luminaires may be known to degrade or diminish below a stated operational output. For example, processing unit 205,304 may be configured to record a number of hours which a luminaire may be in use, and generate a warning signal when the number of hours in use exceeds a known duration after which the luminaire's luminosity output may fall below its stated operational output or fall within or below a predetermined percentage of its stated operational output.

If the luminosity intensity of a luminaire approaches or falls below a predetermined threshold, or approaches or exceeds a predetermined duration of service, the luminosity intensity monitoring system may be configured to present a visible warning signal, an audible warning signal, or combinations thereof, or it may alter, modulate, or cut power to the luminaire, which may further be accompanied by one or more visible or audible indications. In embodiments, the visible or audible indications may be continuous, while in alternate embodiments, the visible or audible indications may be intermittent or periodic. Examples of embodiments of a visual indication may include a red indicator on a control panel, which remains illuminated or flashes continuously or periodically to provide notification of the diminished output status of a luminaire. Such a visual indication may be accompanied by an audible alarm, which may be audible continuously or periodically.

In embodiments, the system for monitoring illumination intensity may be provided within a single luminaire, a plurality of luminaires, or a distributed system of discrete components disposed about a craft, vessel, object, or structure, which may function in isolation or in coordination with other such components disposed elsewhere about the craft, vessel, object, or structure. For example, in an embodiment for the maritime industry, a single navigation control panel may be disposed on a vessel which is configured to monitor the luminosity intensity of a plurality of navigation lights placed about the vessel. In this manner, each of the plurality of navigation lights may comprise components within the housing of the luminaire which may be in communication with a navigation control panel, which may be configured to present a visible or audible warning if the luminosity intensity of any one of the plurality of navigation lights falls below a predetermined quantity of lumens, a predetermined percentage of a specified measure of lumens, or exceeds a predetermined duration of use.

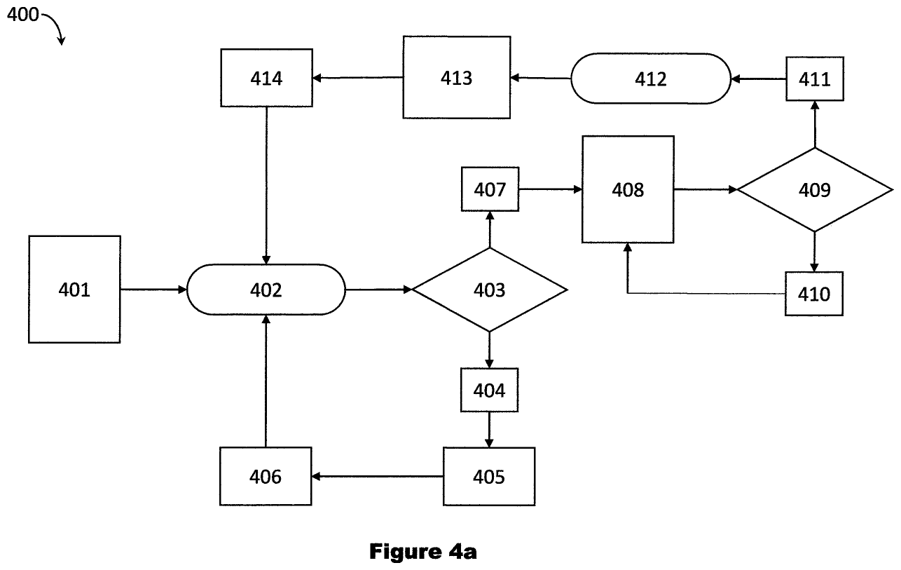

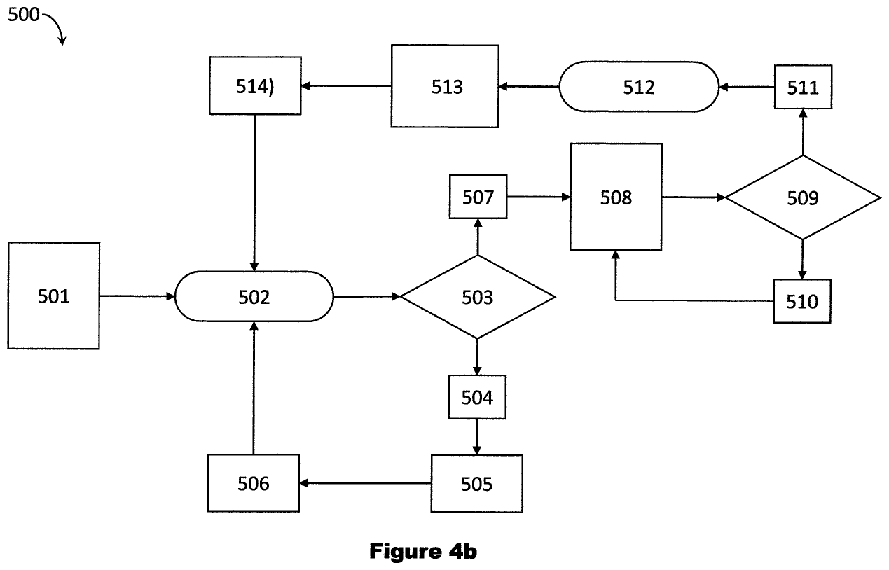

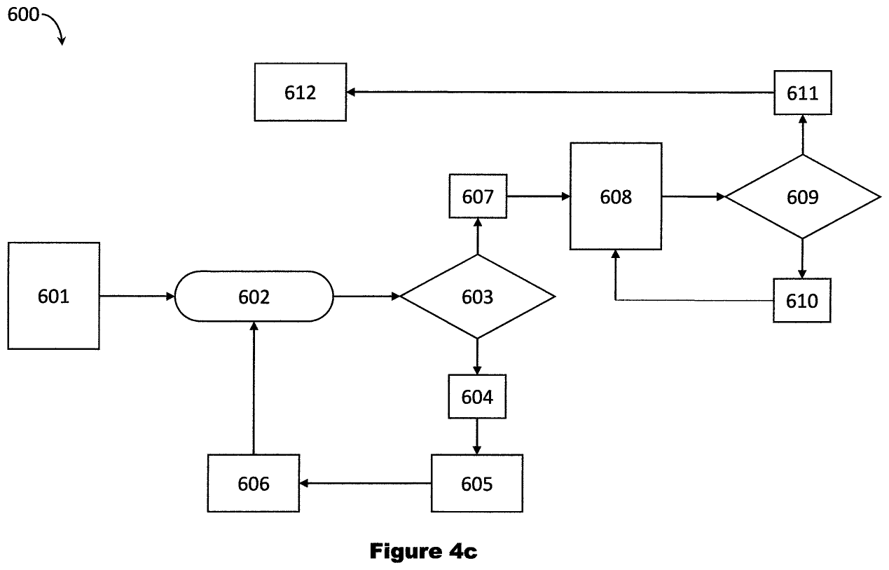

FIGS. 4a-4c illustrate embodiments of methods 400, 500, and 600 which may be employed for implementing system 200,300 under operational conditions. Each method 400,500,600 may be applied to a single luminaire, a plurality of luminaires, or a distributed system which monitors a luminosity intensity of one or more luminaires. In embodiments, each method 400,500,600 may be applied alone or in combination with one or more methods 400, 500, or 600.

Methods 400, 500, and 600 share several procedural steps which may share common activities. Following installation of the luminosity monitoring system 200,300, at method step 401,501,601 power may switched to a functional state which may cause the luminosity monitoring system 200,300 to become activated at method step 402,502,602. The method may then proceed to method step 403,503,603, wherein processing unit 205,304 may determine if one or more luminaires may be illuminated in an operational state. In alternate embodiments, method step 403,503,603 may be performed by one or more persons having access to luminosity monitoring system 200,300.

If one or more luminaires may not be illuminated after power is switched to a functional state, method 400,500,600 may proceed through branch 404,504,604 to method step 405,505,605 wherein the one or more persons having access to luminosity monitoring system 200,300 may inspect one or more power connections of luminosity monitoring system 200,300 to determine whether a power connection may be failing, at method step 405,505,605, or whether one or more components of luminosity monitoring system 200,300 may be in need of replacement, illustrated as method step 406,506,606. Upon remediation of a power connection of luminosity monitoring system 200,300, or replacement of a component of luminosity monitoring system 200,300, method 400,500,600 may then return to method step 402,502,602, wherein luminosity monitoring system 200,300 may be reactivated, and proceed again to method step 403,503,603, wherein processing unit 205,304, or one or more persons having access to luminosity monitoring system 200,300, may again determine if the one or more luminaires may be illuminated in an operational state.

If method step 403,503,603 results in a determination that the one or more luminaires are illuminated in an operational state, method 400,500,600 may progress to method step 408,508,608, wherein luminosity monitoring system 200,300 may monitor an illumination intensity of each of the one or more luminaires comprising, or configured to be monitored by, luminosity monitoring system 200,300. Method step 408,508,608 may optionally include storing, retrieving, transmitting, or receiving data relating to the one or more luminaires (not shown) or combinations thereof, for example data relating to a luminosity output, a temperature, a service life, or similar data relating to the one or more luminaires. The method may then proceed to method step 409,509,609, wherein luminosity monitoring system 200,300 may determine whether the illumination intensity of each of the one or more luminaires may be acceptable based upon criteria which may be unique to method 400, 500, or 600, which will be described separately. For as long as luminosity monitoring system 200,300 determines at method step 409,509,609 that the illumination intensity of each of the one or more luminaires is acceptable, method 400,500,600 may loop continuously between method step 408,508,608, method step 409,509,609, and method step 410,510,610 until luminosity monitoring system 200,300 determines that an illumination intensity of at least one of the one or more luminaires may not be acceptable, at which point methods 400, 500, and 600 may proceed along unique paths as follows to remain compliant with a minimum distance of visibility which may be regulated by civil authorities.

In method 400, illustrated in FIG. 4a, determining whether the luminosity output of a luminaire remains acceptable at method step 409 may be based upon comparing a measured luminosity intensity of a luminaire to a minimally acceptable luminosity intensity, which may comprise a preset quantity of lumens or a predetermined percentage of a specified measure of lumens, as previously described. If the luminaire's intensity is determined to be unacceptable at method step 411, method 400 may proceed to method step 412, wherein power to the luminaire may be switched off temporarily or modulated by luminosity monitoring system 200,300 as part of an early warning signal. Method 400 may then proceed to method step 413, wherein luminosity monitoring system 200,300 may present a visible or audible warning alarm in the manner previously described, which may prompt the one or more persons having access to luminosity monitoring system 200,300 to replace the unacceptable luminaire at method step 414. Following replacement of the unacceptable luminaire, method 400 may then return to method step 402, wherein luminosity monitoring system 200,300 may be re-activated.

In method 500, illustrated in FIG. 4b, determining whether the luminosity output of a luminaire remains acceptable at method step 509 may be based upon comparing a recorded duration of use of a luminaire to a predetermined duration of use, which may indicate the luminaire's illumination intensity may be diminished as a result of nearing the end of serviceable life having been consumed, as previously described. If the luminaire's intensity is determined to be unacceptable at method step 511, method 500 may proceed to method step 512, wherein power to the luminaire may be switched off temporarily or modulated by luminosity monitoring system 200,300 as part of an early warning signal. Method 500 may then proceed to method step 513, wherein luminosity monitoring system 200,300 may present a visible or audible warning signal in the manner previously described, which may prompt the one or more persons having access to luminosity monitoring system 200,300 to replace the unacceptable luminaire at method step 514. Following replacement of the unacceptable luminaire, method 500 may then return to method step 502, wherein luminosity monitoring system 200,300 may be re-activated.

In method 600, illustrated in FIG. 4c, determining whether the luminosity output of a luminaire remains acceptable at method step 609 may be based upon comparing a measured luminosity intensity of a luminaire to a minimally acceptable luminosity intensity, which may comprise a predetermined quantity of lumens or a predetermined percentage of a specified measure of lumens, as previously described. If the luminaire's intensity is determined to be unacceptable at method step 611, indicating the luminaire may no longer be able to remain in compliance with a regulated minimal visibility, method 600 may proceed to method step 612, wherein power to the luminaire may be switched off permanently by luminosity monitoring system 200,300. In embodiments, method 600 may be implemented following implementation of one or more implementations of method 400, which may be performed at a predetermined frequency, for example daily or nightly.

The systems and methods described herein may provide advantages over prevailing practices for maintaining compliance where a source of illumination may be desired or specified to meet or exceed a specified level of observability at a specified distance, in compliance with regulatory guidelines. In addition to these compliance advantages, the systems and methods described herein may also provide cost advantages over prevailing practices by enabling a reduction in the number of spare luminaires which may need to be available. For example, in an embodiment for the maritime industry, a single spare luminaire may be suitable for a first grouping of navigation lights, for example those providing a visibility of 3 nautical miles, while a single spare may be suitable for a second grouping of navigation lights, for example those providing a visibility of 6 nautical miles.

Although the present invention and its advantages have been described in detail, it should be understood that various changes, substitutions and alterations may be made herein without departing from the spirit and scope of the invention as defined by the appended claims.

What is claimed is:

1. A method of remaining compliant with a regulated minimum visibility of a luminaire, comprising:
a. receiving a regulated minimum visibility of a luminaire;
b. correlating the regulated visibility to an observable luminosity intensity;
c. providing a luminaire capable of producing an illumination comprising a produced luminosity intensity when powering the luminaire;
d. powering the luminaire and measuring the produced luminosity intensity to provide a measured luminosity intensity, wherein the measuring optionally includes storing, retrieving, transmitting, or receiving data relating to the one or more luminaires, or combinations thereof; and
e. generating a notification if the measured luminosity intensity is less than the observable luminosity intensity.

2. The method of claim 1, wherein the notification comprises a visual notification.

3. The method of claim 1, wherein the notification comprises an audible notification.

4. The method of claim 1, further comprising suspending the powering the luminaire after a predetermined time following the generating the notification.

5. The method of claim 1, wherein the measuring is performed by one or more sensors, one or more processing units, or combinations thereof.

6. The method of claim 5, wherein the one or more processing units comprises hardware, software, or a combination of hardware and software.

7. A method of remaining compliant with a regulated minimum visibility of a luminaire, comprising:
a. receiving a regulated minimum visibility of a luminaire;
b. correlating the regulated visibility to an observable luminosity intensity;
c. providing a luminaire capable of producing an illumination comprising a produced luminosity intensity when powering the luminaire;
d. determining a service life of the luminaire, wherein the service life comprises a duration of time after which the produced luminosity intensity is estimated to diminish to be less than the observable luminosity intensity;
e. powering the luminaire over a duration of time to provide an operating life, wherein the operating life comprises a cumulative duration of time which has elapsed following the powering
f. comparing the operating life to the service life, wherein the comparing optionally includes storing, retrieving, transmitting, or receiving data relating to the one or more luminaires, or combinations thereof; and
g. generating a notification when the operating life exceeds the service life.

8. The method of claim 7, wherein the notification comprises a visual notification.

9. The method of claim 7, wherein the notification comprises an audible notification.

10. The method of claim 7, further comprising suspending the powering the luminaire after a predetermined time following the generating the notification.

11. The method of claim 7, wherein the comparing is performed by one or more processing units.

12. The method of claim 11, wherein the one or more processing units comprises hardware, software, or a combination of hardware and software.

13. A method of remaining compliant with a regulated minimum visibility of a luminaire, comprising:
a. receiving a regulated minimum visibility of a luminaire;
b. correlating the regulated visibility to an observable luminosity intensity;
c. providing a luminaire comprising a stated luminosity intensity equal to the observable luminosity intensity, wherein the luminaire is capable of producing an illumination comprising a produced luminosity intensity when powering the luminaire;
d. powering the luminaire and measuring the produced luminosity intensity to provide a measured luminosity intensity, wherein the measuring optionally includes storing, retrieving, transmitting, or receiving data relating to the one or more luminaires, or combinations thereof;
e. determining a percentage difference between the measured luminosity intensity and the observable luminosity intensity; and
f. generating a notification if the measured luminosity intensity is less than the stated luminosity intensity and the percentage difference exceeds a predetermined percentage.

14. The method of claim 13, wherein the notification comprises a visual notification.

15. The method of claim 13, wherein the notification comprises an audible notification.

16. The method of claim 13, further comprising suspending the powering the luminaire after a predetermined time following the generating the notification.

17. The method of claim 13, wherein the measuring is performed by one or more sensors, one or more processing units, or combinations thereof.

18. The method of claim 17, wherein the one or more processing units comprises hardware, software, or a combination of hardware and software.
